(19) United States
(12) Patent Application Publication
(10) Pub. No.: US 2009/0014034 A1
(43) Pub. Date: Jan. 15, 2009

(54) BENEFIT COMPOSITIONS AND FORMALDEHYDE SCAVENGERS FOR SAME

(75) Inventors: Jiping Wang, Cincinnati, OH (US); Shannon Dale Wagers, Liberty Township, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company

(21) Appl. No.: 12/201,425

(22) Filed: Aug. 29, 2008

Related U.S. Application Data
(63) Continuation-in-part of application No. 11/986,128, filed on Nov. 20, 2007.
(60) Provisional application No. 60/861,483, filed on Nov. 28, 2006.
(60) Provisional application No. 60/860,585, filed on Nov. 22, 2006.

(51) Int. Cl. C08K 5/21; C11D 17/08; D06M 23/00; B08B 7/00

(52) U.S. Cl. 134/19; 524/211; 510/338; 252/8.91

(57) ABSTRACT

Cleaning and/or benefit compositions comprising a formaldehyde-generating agent, particularly a formaldehyde-containing crosslinking agent, and a formaldehyde scavenger are disclosed. Processes for making and using the aforementioned compositions are further disclosed.

### CROSS REFERENCE TO RELATED APPLICATION

This application is a continuation-in-part of and claims priority under U.S. 35 USC § 120 to U.S. application Ser. No. 11/986,128 filed Nov. 20, 2007, which claims priority under 35 U.S.C. § 119(e) to U.S. Provisional Application Ser. No. 60/861,483 filed Nov. 28, 2006 and U.S. Provisional Application Ser. No. 60/860,585 filed Nov. 22, 2006.

### FIELD OF THE INVENTION

This invention relates to cleaning and/or treatment compositions comprising a formaldehyde-generating component and a formaldehyde scavenger. In another aspect, the invention relates to a method of reducing formaldehyde in cleaning and/or benefit compositions.

### BACKGROUND OF THE INVENTION

Cross-linking agents are often used in products to impart selective benefits to a textile or other surface via cross-linking of the benefit agent to the textile or surface. Commonly used crosslinking agents include those containing formaldehyde. However, compositions comprising formaldehyde-containing crosslinking agents tend to produce formaldehyde, which can give rise to unacceptable formaldehyde levels due to degradation of the crosslinking agents. While conventional formaldehyde scavengers, such as ethylene glycol, propylene glycol, succinimide, acetoacetamide, acetonitrile, benzotriazole, butryamide, glycerin, NH₄OH, proinoamide, acetamide, may be used to decrease the formaldehyde concentration of such compositions, such agents are not necessarily suitable for all applications. For example, applicants have found that conventional formaldehyde scavengers such as those named above typically cause yellowing at high temperatures (temperatures in excess of about 130° Celsius). This problem is particularly acute when such compositions are applied to a textile, and a curing or ironing step is performed. Without intending to be limited by theory, it is believed that the problem of textile yellowing at high temperatures using conventional formaldehyde scavengers is caused by the amine or OH— structure that is typically found in these agents.

Applicants have also found that conventional formaldehyde scavengers can impair cross-linking agent activity, thus diminishing the overall efficacy of the benefit composition. Applicants have further found that, in some instances, conventional formaldehyde scavengers can actually cause the formaldehyde-containing crosslinking agent to release more formaldehyde due to the nature of the reactions involved, thus compounding the problem of formaldehyde accumulation.

Thus, there is a need for effective formaldehyde scavengers, particularly for use with compositions containing formaldehyde-containing crosslinking agents, which do not cause yellowing of textiles at high temperatures and which do not impair the efficacy of formaldehyde-containing crosslinking agents. The present invention addresses these needs.

### SUMMARY OF THE INVENTION

The present invention relates to textile benefit compositions comprising a polyurethane and/or a polyurethane co-polymer; a cross-linking agent; a formaldehyde scavenger, and a carrier. In one aspect, the invention relates to a method of reducing formaldehyde in these compositions, and similar compositions comprising formaldehyde-containing crosslinking agents.

### DETAILED DESCRIPTION OF THE INVENTION

### Definitions

As used herein, the articles “a” and “an” when used in a claim, are understood to mean one or more of what is claimed or described.

As used herein “consumer products” includes, unless otherwise indicated, articles, baby care, beauty care, fabric & home care, family care, feminine care, health care, snack and/or beverage products or devices intended to be used or consumed in the form in which it is sold, and is not intended for subsequent commercial manufacture or modification. Such products include but are not limited to diapers, bibs, wipes; products for and/or methods relating to treating hair (human, dog, and/or cat), including bleaching, coloring, dyeing, conditioning, shampooing, styling; deodorants and antiperspirants; personal cleansing products, including cleansers, moisturizing cleansers, and combinations thereof; cosmetics; skin care including application of creams, lotions, mousses, masks, exfoliating compositions, peels, and combinations thereof; hair removal products, including device-assisted hair removal products; shaving products; and other topically applied products for consumer use; products for and/or methods relating to treating fabrics, hard surfaces and any other surfaces in the area of fabric and home care, including: air care, car care, dishwashing, fabric conditioning (including softening), laundry detergency, laundry and rinse additive and/or care, hard surface cleaning and/or treatment, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening; over-the-counter health care including cough and cold remedies, pain relievers, pet health and nutrition, and water purification.

As used herein, the term “fabric cleaning and/or treatment composition” includes, unless otherwise indicated, tablet, granular or powder-form all-purpose or “heavy-duty” washing agents, especially cleaning detergents; liquid, gel or paste-form all-purpose washing agents, for example the so-called heavy-duty liquid types; liquid fine-fabric detergents; as well as cleaning auxiliaries such as bleach additives and “stain-stick” or pre-treat types substrate-laden products such as dryer added sheets, dry and wetted wipes and pads, nonwoven substrates, and sponges; as well as sprays and mists.

Unless otherwise noted, all component or composition levels are in reference to the active portion of that component or composition, and are exclusive of impurities, for example, residual solvents or by-products, which may be present in commercially available sources of such components or compositions.

### Formaldehyde Scavengers

As used herein, the term “formaldehyde scavenger” is intended to include any agent capable of reducing the formaldehyde concentration of a composition or preventing formaldehyde formation in a composition. Applicants have now found that certain agents can be successfully used as formaldehyde scavengers, particularly in combination with formaldehyde-containing crosslinking agents, without incurring the problems typically associated with conventional formaldehyde scavengers as described above. Applicants have further found that the formaldehyde scavengers described herein do not cause discoloration, and do not compromise crosslinking agent efficacy as compared to conventional formaldehyde scavengers. Thus, the formaldehyde scavengers described herein are effective in reducing formaldehyde concentrations while addressing the problems of the art. In one aspect, the instant invention relates to cleaning or benefit compositions comprising a formaldehyde-generating agent and a formaldehyde scavenger.

In a yet further aspect, the instant invention relates to cleaning or benefit compositions comprising a formaldehyde-containing crosslinking agent and a formaldehyde scavenger.

In one aspect, the formaldehyde scavengers of the instant invention may comprise any formaldehyde scavenger generally having the structure of Formula I, below:

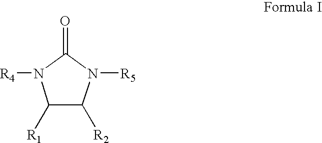

wherein R₁ and/or R₂ are selected from the group consisting of H, OH, NH₂, NHR₃ (where R₃ is selected from the group consisting of alkyl (C₁-C₆), alkyloxy, and alkyamine) and COOH; and R₄ and R₅ are selected from the group consisting of H, alkyl (C₁-C₆), and alkyloxy; wherein at least one of R₄ or R₅ is a hydrogen.

Under ordinary circumstances, the formaldehyde-containing crosslinking agents may degrade into one or more reaction products, yielding free formaldehyde which can accumulate to unacceptable levels. While not intending to be limited by theory, Applicants believe that the addition of the reaction product, or a structurally similar compound, prevents degradation of the crosslinking agent by driving the reaction in a direction which prevents formaldehyde formation, thereby reducing formaldehyde concentrations to acceptable concentrations.

In one aspect, DHEU (4,5-dihydroxyl ethylene urea) is used as the formaldehyde scavenger. In this aspect, the formaldehyde-containing crosslinking agent DMDHEU (dimethylol dihydroxyl ethylene urea) or its derivatives may be used. Applicants believe addition of DHEU inhibits DMDHEU degradation by creating a reaction product mediated shift in equilibrium. As such, the crosslinking agent remains intact, and formaldehyde concentration is greatly decreased or eliminated as compared to a composition that does not contain a formaldehyde scavenger. Table I depicts exemplary data.

Applicants believe that the reaction that occurs where DHEU is used as the formaldehyde scavenger may be exemplified as follows:

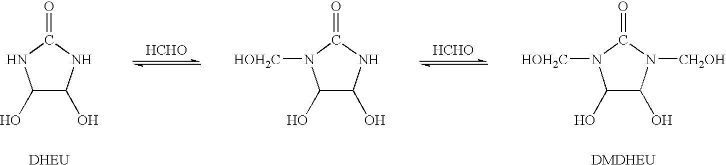

, bathroom cleaners, hair shampoos and hair-rinses, etc. In other embodiments, the composition may be primarily a benefit composition, wherein the composition is used to impart a selective benefit (such as In another aspect, ethylene urea may be used as the formaldehyde scavenger. In this aspect, again, without intending to be limited by theory, the ethylene urea reacts with formaldehyde to create DMEU (dimethylol ethylene urea), which acts a crosslinking agent. This reaction is exemplified as follows:

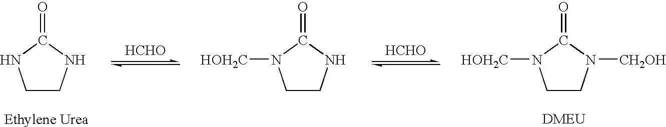

In another aspect, the formaldehyde scavenger used is urea.

In another embodiment, the formaldehyde scavenger is selected from the group consisting of DHEU, ethylene urea, and urea and mixtures thereof.

### Compositions

In one aspect, a composition of the instant invention comprises a formaldehyde-containing crosslinking agent; a formaldehyde scavenger selected from the group consisting of ethylene urea, urea, 4,5-dihydroxyl ethylene urea, and mixtures thereof; one or more optional adjunct ingredients; and a carrier. In a further aspect, the formaldehyde-containing crosslinking agent is selected from the group consisting of methylol and alkoxymethyl derivatives of urea, methylol and alkoxymethyl derivatives of ethylene urea, methylol and alkoxymethyl derivatives of propylene urea, and mixtures thereof. The composition may be, for example, a cleaning composition, such as granular or powder-form all-purpose or “heavy-duty” washing agents, especially laundry detergents; liquid, gel or paste-form all-purpose washing agents; liquid fine-fabric detergents, liquid cleaning and disinfecting agents, laundry bars, carpet shampoos, for example, an anti-wrinkle or softening benefit) to a textile or other surface.

In one aspect, a composition of the instant invention comprises from about 0.1% to about 30%, from about 0.5% to about 20%, from about 1% to about 10% , or from about 1.5% to about 8% by weight of a polyurethane material selected from the group consisting of a polyurethane, a polyurethane copolymer and mixtures thereof, said polyurethane and polyurethane having a Tg of from about −50° C. to about 150° C., from about −30° C. to about 100° C., from about −10° C. to about 80° C., or even from about 20° C. to about 60° C.; a cross-linking agent, said crosslinking agent being present in a ratio of polyurethane to crosslinking agent of from about 100:1 to about 1:2, from about 50:1 to about 1:1, from about 20:1 to about 3:2, or even from about 10:1 to about 2:1; a catalyst, said catalyst being present in a ratio of crosslinking agent to catalyst of from about 100:1 to about 1:5, from about 50:1 to about 1:1, from about 20:1 to about 3:2, or even from about 10:1 to about 2:1; a formaldehyde scavenger, said formaldehyde scavenger being present in an amount of from 0.1% to about 10% or about 0.3% to about 5% or about 0.5% to 3% or about 1% to about 2% by weight of the total composition; and an optional adjunct ingredient with the balance of said composition being a carrier, for example water, is disclosed.

In one aspect, a composition having the aforementioned parameters and wherein said polyurethane material comprises a material having Formula II below:

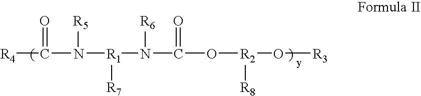

wherein:

a.) R₁ and R₂ are independently selected from an aryl, heteroaryl, alkyl or a heteroalkyl group that can be substituted or unsubstituted;

b.) R₃, R₅ and R₆ are independently selected from H, a polymer or an aryl, heteroaryl, alkyl or a heteroalkyl group;

c.) R₄ is OH, a polymer or an aryl, heteroaryl, alkyl or a heteroalkyl group ; and

d.) R₇ and R₈ are independently selected from H, an aryl, heteroaryl, or alkyl group that can be substituted or unsubstituted

e.) y is an integer from 1-200, 1-100, 1-50, 1-20, 1-10, or 1-5 is disclosed.

In one aspect, a composition having the aforementioned parameters and wherein said polyurethane material comprises a material having Formula II above wherein:

a.) R₁ is selected from 4,4′-diphenylmethane, benzene, carbodiimide-modified 4,4′-diphenylmethane, and hexamethylene

b.) R₂ is selected from polypropylene glycol, polyethylene glycol, 1,4-butane glycol adipate, 1,4-butane, 1,3-propane, ethane, 4,4′-dihydroxy biphenyl, and 2,2′-dimethylolpropanic acid;

c.) R₃, R₄, R₅ and R₆ are independently selected from silicones, polyethylene, polypropylene, functionalized substituted waxes, fatty esters, polyamines, polyacrylates, carboxylic acids, and polycarboxylic acids; and

d.) R₇ and R₈ are independently selected from an aryl, heteroaryl, or alkyl group that can be substituted or unsubstituted is disclosed.

In any of the aspects of the compositions that are disclosed in the present specification, said cross-linking agent may comprise a material selected from the group consisting of methylol and alkoxymethyl derivatives of urea and of ethylene or propylene urea, and mixtures thereof. In another aspect, the crosslinking agent is a formaldehyde-containing crosslinking agent.

In any of the aspects of the compositions that are disclosed in the present specification, said compositions may comprise a lubricant. Said lubricant may comprise a material selected from the group consisting of a fatty ester, a silicone, a polyethylene emulsion and mixtures thereof.

In any of the aspects of the compositions that are disclosed in the present specification, said compositions may comprise an optional adjunct ingredient that comprises a material selected from the group consisting of a perfume, perfume delivery system, wetting agent, softening agent, hair conditioning agent, skin care agent, stain repellant, soil release agent, antistatic agent, moisture management agent, dye fixative, dye transfer inhibitor, color enhancer, substrate hand builder, anti-abrasion agent and mixtures thereof. In one aspect, said optional ingredients may comprise, based on total composition weight, from about 0.001% to about 30%, from about 0.01% to about 20% or even from about 0.05% to about 10% of said composition.

In any of the aspects of the compositions that are disclosed in the present specification, said catalyst may comprise a material selected from the group consisting of acids, latent acids, metal salts and mixtures thereof.

In any of the aspects of the compositions disclosed in the present specification, said formaldehyde scavenger may comprise a compound having the structure of Formula I, above.

In another aspect, the formaldehyde scavenger may be selected from the group consisting of DMEU, ethylene urea, urea, or mixtures thereof, wherein the formaldehyde scavenger is present in the amount of 0.1% to about 10% or about 0.3% to about 5% or about 0.5% to 3% or about 1% to about 2% by weight of the total composition. In yet another aspect, the formaldehyde scavenger is DMEU.

### Materials

The preparation of DMEU is described in U.S. Pat. No. 4,650,877. In brief, DMEU may be prepared by the following procedure: 2 moles of glyoxal (290.15 ml of 40% water solution) is added to a 1 L round bottom flask. 25% Na₂CO₃ solution is added to the flask to adjust the pH to about 5 to about 5.5 under stirring. Two moles of urea (120.10 g) is added to the flask under stirring. The exothermic reaction temperature is controlled at 45° C. using a water bath, if necessary. The mixture is continuously stirred for 3 hours at 45-50° C., and then cooled to room temperature. Another 0.2 mole (12 g) of urea is added to the solution to complete the synthesis. Ethylene urea may be obtained from Aldrich, Milwaukee, Wis.. Urea may be obtained from Aldrich, Milwaukee, Wis.

Suitable polyurethanes and polyurethane copolymers may be made by following the teachings of the present specification and U.S. Patent Application No. 2005/0107563 A1.

Suitable cross-linking agents may be obtained from Sigma-Aldrich of St. Louis, Mo. U.S.A., and Noveon, Inc. of Cleveland, Ohio U.S.A.

Suitable catalysts may be obtained from Sigma-Aldrich of St. Louis, Mo. U.S.A.

Suitable lubricants may be obtained from Akzo Nobel of Velperweg 76, 6824 BM Arnhem, The Netherlands, and The Dow Coming Corporation of Midland, Mich. U.S.A.

Suitable optional adjunct ingredients may be obtained from International Flavors & Fragrances of New York, N.Y. U.S.A., BASF Aktiengesellschaft of Ludwigshafen, Germany, Ciba Specialty Chemicals Inc., of Basel, Switzerland, and Clariant International Ltd, of Muttenz, Switzerland.

### Process of Making Compositions

Compositions disclosed in the present specification may be made by combining the materials, as disclosed in the present specification, in the amounts disclosed in the present specification. Such combining may be achieved by any combining process included batch, semi-batch and continuous processes.

### Product

In one aspect, a finished consumer product comprising packaging and any of the compositions disclosed in the present specification is disclosed. In one aspect, said finished consumer product may comprise a container containing, at least in part, any of the compositions disclosed in the present specification.

### Treatment Method

The instant invention further relates to a method of reducing formaldehyde concentration in a composition, comprising the steps of: providing a composition comprising formaldehyde or a formaldehyde-containing crosslinking agent; and providing a formaldehyde scavenger selected from the group consisting of ethylene urea, DHEU, urea, and mixtures thereof, in an amount effective to reduce formaldehyde concentration in the composition. In one aspect, the formaldehyde scavenger is provided in an amount of about 0.1% to about 10% or about 0.3% to about 5% or about 0.5% to 3% or about 1% to about 2% by weight of the total composition. In a further aspect, the formaldehyde scavenger is DHEU, and the formaldehyde-containing crosslinking agent is dimethylol dihydroxyl ethylene urea.

In one aspect, a method of treating a consumer textile product, hair or combination thereof that may comprise the steps of:

a.) contacting at least a portion of said consumer textile product, hair or combination thereof with any of the compositions disclosed in the present specification;

b.) drying at least a portion of said consumer textile product, hair or combination thereof that was in contact with any of the compositions disclosed in the present specification.

In one aspect, said drying may be achieved by ironing and/or pressing consumer textile product.

In one aspect, said contact is achieved by spraying or soaking said consumer textile product with any of the compositions disclosed in the present specification.

In one aspect, said consumer textile product, hair or combination thereof is treated prior to said textile product being used by end user.

### Treated Product

In one aspect, a treated product, produced by treating said product treated according to the treatment methods disclosed in the present specification, is disclosed.

### EXAMPLES

### Example 1

### Formulation

| Chemical | Weight % |
|---|---|
| Polyurethane | 6.5 |
| Dimethylol Dihydroxy ethylene urea | 2.0 |
| Diethylene glycol | 1.5 |
| Polyethylene glycol | 0.5 |
| MgCl₂ | 0.5 |
| Methanol | 0.3 |
| Water | Balance to 100% |

### Example 2

### Spray-Iron Application

A fabric comprising 100% cotton fibers is placed on an ironing board and the composition of Example 1 is evenly sprayed on the fabric in a sufficient amount to achieve a wet pick up at about 50%. The fabric is then ironed until it is dry using a high temperature setting.

### Example 3

### Soak-Iron Application

About 200 g of the composition of Example 1 is combined with 1000 g of water. The resulting mixture is stirred and/or agitated. The garments, which include a shirt comprising 100% cotton fibers are placed in a container containing such mixture and agitated for about 5 minutes. The garments are then spun in a washer for 2 minutes and then ironed until it is dry.

### Example 4

### Soak-Iron Application

About 200 g of the composition of Example 1 is combined with 1000 g of water. The resulting mixture is stirred and/or agitated. The garments, which include a shirt comprising 50% cotton fibers and 50% polyester fibers are placed in a container containing such mixture and agitated for about 5 minutes. The garments are then spun in a washer for 2 minutes and then ironed until it is dry.

Table 1 shows anti-wrinkle benefit and fabric whiteness for benefit compositions having the formula shown in Example 2, wherein the composition comprises either a conventional formaldehyde scavenger (acetoacetamide) or one or more formaldehyde scavengers of the instant invention (DHEU, Urea, and Ethylene Urea (“EU”)).

TABLE I

| | I | II | III | IV | V |
|---|---|---|---|---|---|
| | Formula of | Formula of | Formula of | Formula of | Formula of |
| Composition | Example 1 | Example 1 | Example 1 | Example 1 | Example 1 |
| Formaldehyde | — | Acetoacetamide | DHEU | DHEU (2%) | DHEU (2%) |
| Scavenger | | (1%) | (1%) | Urea (0.5%) | EU (0.25%) |
| (% Total | | | | | |
| Composition) | | | | | |
| Formaldehyde | 593 | 23 | 63 | 59 | 37 |
| (ppm) | | | | | |
| Wrinkle | | | | | |
| Control | | | | | |
| Performance | 3.32 | 3.35 | 3.55 | 3.21 | 3.25 |
| Rating | | | | | |
| Fabric | | | | | |
| Whiteness | 83.5 | 73.4 | 83.1 | 83.0 | 83.0 |

### Methods

With respect to the data shown in Table I, formaldehyde concentrations in the formulations are measured using the DNPH HPLC method. The formaldehyde in the sample solution is derivatized using 2,4-dinitrophenylhydrazine (DNPH). The derivative is then analyzed by reversed phase high performance liquid chromatography with PDA (Photo Diode Array) detection and quantification at 365 nm. Wrinkle Control Performance Rating for the data shown in Table I is measured using the AATCC smoothness grade and AATCC Test Method 124; Fabric Whiteness for the data shown in Table I is measured by whiteness index using AATCC Evaluation Procedure 6: Instrumental Color Measurement.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising:
a. a formaldehyde-containing crosslinking agent selected from the group consisting of methylol and alkoxymethyl derivatives of urea, methylol and alkoxymethyl derivatives of ethylene urea, methylol and alkoxymethyl derivatives of propylene urea, and mixtures thereof;
b. a formaldehyde scavenger selected from the group consisting of ethylene urea, urea, and 4,5-dihydroxyl ethylene urea; and
c. an optional adjunct ingredient.

2. A composition according to claim 1 wherein the formaldehyde scavenger is DHEU.

3. A composition according to claim 1 wherein the formaldehyde scavenger is present in an amount of about 0.1% to about 10% of the total composition.

4. A composition according to claim 1 wherein the formaldehyde-containing crosslinking agent is dimethylol dihydroxyl ethylene urea.

5. A composition comprising:
a. from about 0.1% to about 30%, by weight of a polyurethane material selected from the group consisting of a polyurethane, a polyurethane copolymer and mixtures thereof, said polyurethane and polyurethane having a Tg of from about −50° C. to about 150° C.;
b. a cross-linking agent, said crosslinking agent being present in a ratio of polyurethane to crosslinking agent of from about 100:1 to about 1:2;
c. a catalyst, said catalyst being present in a ratio of crosslinking agent to catalyst of from about 100:1 to about 1:5;
d. a formaldehyde scavenger selected from the group consisting of ethylene urea, urea, and 4,5-dihydroxyl ethylene urea;
e. an optional adjunct ingredient.

6. A composition according to claim 5 wherein said polyurethane material comprises a material having Formula II below: 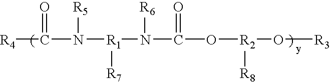
wherein:
a. R₁ and R₂ are independently selected from an aryl, heteroaryl, alkyl or a heteroalkyl group that can be substituted or unsubstituted;
b. R₃, R₅ and R₆ are independently selected from H, a polymer or an aryl, heteroaryl, alkyl or a heteroalkyl group;
c. R₄ is OH, a polymer or an aryl, heteroaryl, alkyl or a heteroalkyl group; and
d. R₇ and R₈ are independently selected from H, an aryl, heteroaryl, or alkyl group that can be substituted or unsubstituted; and
e. y is an integer from 1-200.

7. A composition according to claim 6 wherein said polyurethane material comprises a material having Formula II below: 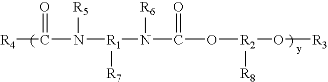
wherein:
a. R₁ is selected from 4,4′-diphenylmethane, benzene, carbodiimide-modified 4,4′-diphenylmethane, and hexamethylene
b. R₂ is selected from polypropylene glycol, polyethylene glycol, 1,4-butane glycol adipate, 1,4-butane, 1,3-propane, ethane, 4,4′-dihydroxy biphenyl, and 2,2′-dimethylolpropanic acid;
c. R₃, R₄, R₅ and R₆ are independently selected from silicones, polyethylene, polypropylene, functionalized substituted waxes, fatty esters, polyamines, polyacrylates, carboxylic acids, and polycarboxylic acids;
d. R₇ and R₈ are independently selected from an aryl, heteroaryl, or alkyl group that can be substituted or unsubstituted.

8. A composition according to claim 5 wherein said crosslinking agent is a formaldehyde-containing crosslinking agent selected from the group consisting of methylol and alkoxymethyl derivatives of urea, methylol and alkoxymethyl derivatives of ethylene urea, methylol and alkoxymethyl derivatives of propylene urea, and mixtures thereof.

9. A composition according to claim 5 wherein the formaldehyde containing crosslinking agent is dimethylol dihydroxyl ethylene urea.

10. A composition according to claim 5 wherein the formaldehyde scavenger is 4,5-dihydroxyl ethylene urea.

11. A composition according to claim 5 comprising a lubricant.

12. A composition according to claim 5 wherein said optional adjunct ingredient comprises a material selected from the group consisting of a perfume, perfume delivery system, wetting agent, softening agent, hair conditioning agent, skin care agent, stain repellant, soil release agent, antistatic agent, moisture management agent, dye fixative, dye transfer inhibitor, color enhancer, substrate hand builder, anti-abrasion agent and mixtures thereof.

13. A composition according to claim 5 wherein said catalyst comprises a material selected from the group consisting of acids, latent acids, metal salts and mixtures thereof.

14. A product comprising packaging and the composition of claim 5, said product being a consumer product.

15. A product according to claim 10 and said packaging comprising a container containing, at least in part, said composition.

16. A method of treating a consumer textile product, hair or combination thereof comprising the steps of:
a. contacting at least a portion of said consumer textile product, hair or combination thereof with the composition of claim 1
b. drying at least a portion of said consumer textile product, hair or combination thereof that was in contact with the composition of claim 1.

17. The method of claim 16 wherein said consumer textile product, hair or combination thereof wherein said drying is achieved by ironing and/or pressing consumer textile product.

18. The method of claim 16 wherein said consumer textile product, hair or combination thereof wherein said contact is achieved by spraying or soaking said consumer textile product with the composition composition comprising:
a. a formaldehyde-containing crosslinking agent selected from the group consisting of methylol and alkoxymethyl derivatives of urea, methylol and alkoxymethyl derivatives of ethylene urea, methylol and alkoxymethyl derivatives of propylene urea, and mixtures thereof;
b. a formaldehyde scavenger selected from the group consisting of ethylene urea, urea, and 4,5-dihydroxyl ethylene urea; and an optional adjunct ingredient.

19. The method of claim 16 wherein said consumer textile product, hair or combination thereof is treated prior to said textile product being used by end user.

20. A textile product treated according to claim 16.

21. A method of reducing formaldehyde in compositions containing a formaldehyde-containing crosslinking agent, comprising the steps of
a. providing a composition comprising formaldehyde or a formaldehyde-containing crosslinking agent; and
b. providing a formaldehyde scavenger selected from the group consisting of ethylene urea, DHEU, urea, and mixtures thereof in an amount effective to reduce formaldehyde concentration in the composition.

22. A method according to claim 21 wherein the formaldehyde scavenger is DHEU.

23. A method according to claim 21 wherein the formaldehyde scavenger is present in an amount of about 0.1% to about 10% of the total composition.

24. A method according to claim 21 wherein the formaldehyde-containing crosslinking agent is dimethylol dihydroxyl ethylene urea.
